(19) United States
(12) Patent Application Publication
(10) Pub. No.: US 2002/0101848 A1
(43) Pub. Date: Aug. 1, 2002

(54) Systems and methods for on-location, wireless access of web content

(76) Inventors: Ivan Lee, San Jose, CA (US); Li Cheng Zai, Los Gatos, CA (US); Max Rible, Sunnyvale, CA (US); William G. Pabst, Sunnyvale, CA (US)

Correspondence Address: SKJERVEN MORRILL MACPHERSON LLP, 25 Metro Drive, Suite 700, San Jose, CA, 95110, US

(21) Appl. No.: 09/731,240

(22) Filed: Dec. 5, 2000

(51) Int. Cl. H04J 3/24; H04L 12/66; H04L 12/56

(52) U.S. Cl. 370/349; 370/352; 370/401

(57) ABSTRACT

A wireless network provides one or more local wireless service area where wireless clients are able to access web content from an IP network that includes the Internet. A wireless network that includes wireless gateways, secure link to a WAP gateway via an access server and location-based content offers an infrastructure for providing valued-added features to wireless clients. The valued-added features include providing web content in multiple application protocols and include automatically presenting location-based content when a wireless client attempts to access web content.

### FIELD OF THE INVENTION

The present invention relates to systems and methods for local wireless telecommunication, and in particular to an infrastructure including one or more local wireless service area where wireless client devices in a service area are presented with associated local content when accessing content from the Intranet/Internet

### ABBREVIATIONS & ACRONYMS

It is customary for the telecommunication industry to use acronyms when referring to established components and services. The ones that are used in this disclosure are listed as follow:

| | |
|---|---|
| HTML | HyperText Markup Language |
| HTTP | HyperText Transfer Protocol |
| I/O | Input/Output |
| ID | Identity Number |
| IP | Internet Protocol |
| IPSec | IP security Protocol |
| LAN | Local Area Network |
| LLC | |
| LMP | Link Management Protocol |
| MAC | Media Access Control |
| MSC | Mobile Switching Center |
| NAT | Network Address Translation |
| PDA | Personal Digital Assistant |
| PHY | Physical Layer of a protocol stack |
| PKI | Public Key Infrastructure |
| POTS | Plain Old Telephone Service |
| PPP | Point-to-Point Protocol |
| PSTN | Public Switched Telephone Network |
| RF | Radio Frequency |
| RAM | Random Access Memory |
| ROM | Read Only Memory |
| SSL | Secure Socket Layer |
| TCP | Transmission Control Protocol |
| UART | Universal Asynchronous Receiver-Transmitter |
| URL | Uniform Resource Locator |
| USB | Universal Serial Bus |
| UTP | User Datagram Protocol |
| VPN | Virtual Private Network |
| XML | Extensible MarkUp Language |
| WAP | Wireless Application Protocol |
| WAE | Wireless Application Environment |
| WDP | Wireless Datagram Protocol |
| WML | Wireless MarkUp Language |
| WSP | Wireless Session Protocol |
| WTLS | Wireless Transport Layer Security |
| WTP | Wireless Transaction Protocol |
| WWW | World-Wide Web |

### BACKGROUND OF THE INVENTION

In recent years, the World-Wide Web (WWW) has become a universal platform for information dissemination on the Internet. Web applications in general and content in the form of web pages in particular are written in HTML (HyperText Markup Language) and are hosted by web servers on private IP (Internet Protocol) networks such as Intranets and public IP networks such as the Internet.

One reason for the widespread acceptance of the WWW is the relative ease with which web applications can be created and deployed, and the existence of standardized web browsers. HTML, with its tag-coding scheme, is now well known to everyone from the professional developer to the savvy end user. More recently, XML (Extensible Markup Language) has been introduced to extend HTML with enhanced features including customizable tags, which allow for more structural specification of data.

The clients for accessing web type of content has extended from desktop computers to increasingly portable devices including notebook computers, palm-top information appliances and mobile phones. There is a constant quest for greater bandwidth and mobility for accessing the content available on the public or private IP networks.

The Internet is a worldwide interconnection of IP networks, with interconnecting computers communicating with each other using TCP/IP (Transmission Control Protocol/Internet Protocol). Some of the computers may also be interconnected by a private segment of the IP network with restricted access. On an IP network, data from a source node is cast into a number of packets that may individually be transported via multiple paths on the network to be reassembled at a destination node. The transmission on the IP network is packet-switched and asynchronous.

FIG. 1 illustrates a conventional wireless local-area network system with connection to the Internet. Wireless-enabled equipment and devices such as wireless-enabled personal computers and mobile devices such as notebooks or personal digital assistants (PDAs) can establish wireless communication with a local area network via a wireless gateway. The local area network (LAN) can in turn provide access to the Internet via an Internet interface. In this way the wireless-enabled equipment is able to establish connectivity to computers and peripherals on the LAN as well as to resources on the Internet such as a web server hosting a HTML/XML application.

For personal wireless connectivity, technologies employing infrared or radio frequency (RF) carrier have emerged as viable solutions. Various industrial working groups are in the process of establishing standards for higher performance systems. These include IEEE 802.11 (Wireless LAN), HomeRF, Bluetooth, and standard wireless access protocol (SWAP).

Currently, the Bluetooth Special Interest Group (http://bluetooth.com), comprising a consortium of telecommunication, computing and networking industries, is in the process of establishing various versions of the Bluetooth specification. It is a specification for small form-factor, low-cost radio solution to provide short-distance (e.g., 10-100 m) link between mobile computers, mobile phones and other portable handheld devices, and connectivity to the Internet.

FIG. 2 illustrates schematically a client retrieving a resource such as the content of a web page from a web server. Each web page can be called up by its URL (Uniform Resource Locator), which comprises an IP address and a path. The IP address points to a host (e.g., a web server) on the Internet and the path points to a file (e.g., a web page) on the host. A web page may be requested and processed by a web browser running on a client computer connected to the Internet. The web browser requests a web page from a web server by its URL and the web server returns the web page to the web browser. The web browser retrieves the web page under HTTP (HyperText Transfer Protocol) and parses the HTML codes on the web page to execute it. Typically, the execution of HTML codes on a web page results in rendering it into a display page on the browser of the client computer. In other instances, it may result in the execution of some backend functions on the client and/or server computers.

Cellular phone service is another wireless telecommunication system that is growing rapidly in the consumer market. The proliferation of cell phones as personal communication devices has provided impetus for developing standards and protocols to enable these highly mobile wireless clients to access web applications hosted on Intranet/internet IP networks.

The Wireless Application Protocol (WAP) is being developed as an application environment and set of communication protocols for enabling wireless mobile devices to access the Internet and telephony services. WAP is being specified and developed by WAP Forum Ltd. (http://www.wapforum.org/), which is a consortium of Internet and telecom companies.

WAP is based on the standards and protocols established for the web environment, such as HT , HTTP and TCP. However, these standards and protocols are inefficient over mobile networks. Furthermore, standard HTML content cannot be effectively be displayed on the small-size screens of handheld mobile phones and pagers.

Mobile networks typically operate under more restricted conditions, such as low bandwidth, high latency, and less connection stability. To address these considerations, WAP compresses the data to be transmitted to alleviate the bandwidth and latency restrictions. Furthermore, the content is created with WML (Wireless Markup Language) and WMLScript, which are optimized for a microbrowser running on a mobile client having a small form-factor display and simple navigation controls.

FIG. 3 illustrates a conventional cellular phone telecommunication network with connection to the Internet for accessing WML applications. Essentially wireless services are provided in areas covered by one or more cells serviced by a wireless gateway such as a Mobile Switching Center (MSC). The MSC primarily allows each wireless mobile unit (e.g., mobile phone) to connect to other telephones and equipment on the Public Switched Telephone Network (PSTN) via a circuit-switched SS7 network.

To provide cell phone users access to web or HTTP content on the Internet, a WAP gateway is typically installed, co-located at the MSC. The WAP gateway provides translation between HTTP packets on the Internet and the WAP packets on the wireless network. In this way, content on the Internet coded in WML is translated from HTTP to WAP across the WAP gateway to be served to a mobile client. In some implementation, the WAP gateway may also include functionalities to translate, HTML coded content to WML coded content. This will enable a mobile client to access a web page (i.e. HTML coded content) directly. However, this type of on-the-fly translation is usually successful on HTML content that has been designed with this application in mind.

FIG. 4 illustrates schematically a wireless client retrieving a resource such as the content of a WAP deck from a web server. (In WAP parlance, a “deck” and a “card” is used instead of a “page” in view of the smaller display.) The scheme is similar to that for a HTTP client shown in FIG. 2, except with the addition of a WAP gateway. Content in the form of a WML application can be called up by its URL (Uniform Resource Locator), which comprises an IP address and a path. The IP address points to a host (e.g., a web server) on the Internet and the path points to a file (e.g., a WML deck) on the host.

The WAP gateway is intermediary between the wireless clients and the web server hosting the WML deck. When a microbrowser running on a wireless client requests the WML deck by its URL, the application protocol used is WAP and the transport protocol is UDP (User Datagram Protocol). The request is made through the WAP gateway acting as a proxy. The WAP gateway translates the application protocol of the request from WAP to HTTP and the transport protocol from UDP to TCP before requesting the deck from the web server. The web server returns the requested deck to the WAP gateway, whereupon it is translated from HTTP to WAP and TCP to UDP. The returned deck, now in WAP is then returned by the WAP gateway to the requesting wireless client. The microbrowser in the wireless client interprets the WML codes on the WAP deck to execute it. Similar to the HTTP case, the execution of WML codes on a WAP deck results in rendering it into a display deck on the microbrowser of the client device. In other instances, it may result in the execution of some backend functions on the client devices and/or server computers.

A WAP-enabled wireless network enables a user to access web content with a mobile device readily. At the same time, by virtue of the context of a user operating in a locality or neighborhood, the possibility exists for providing to the user local content and services associated with that locality.

### OBJECTS AND SUMMARY OF THE INVENTION

Accordingly, it is a general object of the present invention to provide a wireless network infrastructure that is able to provide Internet connectivity and also to serve local content to mobile users economically and efficiently.

It is another object of the invention to provide a wireless network infrastructure that is able to efficiently and economically serve local content under a plurality of application protocols so as to support a plurality of mobile clients.

It is another object of the invention to provide a wireless network infrastructure as stated above that is able to efficiently support additional value-added features for mobile clients.

It is another object of the invention to provide a wireless network infrastructure as stated above that is economical and efficient to install, maintain and administer.

One aspect of the invention provides a wireless network architecture that avoids having to assign a WAP gateway to be co-located with every wireless gateway or every piconet, while providing alternative and enhanced security features. This is accomplished by assigning one or a limited number of WAP gateway to service the whole wireless network. The WAP gateway can be located anywhere as long as it is accessible to the wireless network.

In one embodiment, the WAP gateway is connected to the private IP network via a leased telecommunication line so that no part of it is accessible to the public.

In the preferred embodiment, a more economical and flexible arrangement is to connect the WAP gateway to the private IP network using the public Internet 30. Security is accomplished by establishing a VPN (Virtual Private Network) employing IPsec (IP Security Protocol) for the packets of the IP network to tunnel through the Internet 30. A rule-based a security encoder/decoder is employed.

Using a secured connection across the Internet to share a WAP gateway among the wireless gateways provides a wireless network that is economical, and efficient to manage, maintain and administer. Since the encryption process is off-loaded from the client device to the network infrastructure, performance degradation incurred from secure transactions is reduced. Furthermore, implementing a rule-based secured transport avoids incurring overheads on those applications that do not require security.

According to another aspect of the invention, a system and method of serving local content enable the local content to be actively presented to a mobile wireless user operating in a wireless service area. The local content is information that may be of interest to a mobile user when in the localities or neighborhood covered by the given wireless service area. Alternatively, the local content is information that vendors and businesses in the localities or neighborhood would like to the mobile user to know about. For example, when in an airport terminal, the local content of interest may be the flight schedules of the airlines operating in the terminal, or it may be about the shops and facilities in the terminal. When in a shopping mall, the local content of interest may be about the resident shops and services.

When a mobile user is operating in a wireless service area, the local content is actively presented to the mobile user as an option. In one implementation, when a mobile user initially attempts to access a resource on the Internet/Intranet, the mobile user is automatically redirected to the local content or presented with an option to access the local content. In a preferred implementation, the mobile user can easily navigate between accessing content from the Internet/Intranet and accessing local content. In contrast, conventional methods of serving content of interest to a particular locality require the mobile user to identify the location before the content server can return the relevant local content.

Local content is actively served to a wireless client when the client attempts to request content from the Internet/Intranet. This is accomplished by employ a rule-based packet modifier, in a one-stage process, that either mutates the packets of the requesting client to cause local content to be returned to the client instead, or mutates the packets of the returned content to have the requested content include added local content.

In an alternative embodiment, a two-stage process employs two packet modifiers in tandem. The first packet modifier is positioned in the network to intercept the relevant packets and to modify the IP address of the intercepted packets in order to redirect the packets to the second packet modifier. The second packet modifier then completes the task as stated in the one-stage process.

### BRIEF DESCRIPTION OF THE DRAWINGS

The invention will now be described by way of example with reference to the drawings in which:

FIG. 1 illustrates a conventional wireless local-area network system with connection to the Internet.

FIG. 2 illustrates schematically a client retrieving a resource such as the content of a web page from a web server.

FIG. 3 illustrates a conventional cellular phone telecommunication network with connection to the Internet for accessing WML applications.

FIG. 4 illustrates schematically a wireless client retrieving a resource such as the content of a WAP deck from a web server.

FIG. 5 illustrates a wireless network system that provides wireless devices in a wireless service area access to content hosted on the Intranet/Internet, according to a preferred embodiment of the invention.

FIG. 6 illustrates the process of the security encoder/decoder of FIG. 5 implemented as a rule-based encryption-decryption engine.

FIG. 7A illustrates the path and protocol stacks from a wireless device through a wireless gateway and then tunneling through the Internet.

FIG. 7B illustrates the tunneling path from FIG. 7A through the Internet to the access server and then to the WAP gateway before connecting to the Internet again.

FIG. 8 is a schematic hardware functional block diagram of the wireless gateway shown in FIG. 5.

FIG. 9 illustrates the Bluetooth protocol stack running on the Bluetooth main processor on the motherboard and on the processor on the daughterboard according to the Bluetooth specification.

FIG. 10 is a schematic diagram showing a general system architecture where the wireless network system of FIG. 5 is adapted to serve local content, according to a preferred embodiment of the invention.

FIG. 11 illustrates a preferred scheme for processing packets to implement packet modifications such as packet mutation and packet encryption.

FIG. 12 illustrates the information carried in an IP packet.

FIG. 13A illustrates schematically a packet IP modifier in which the destination IP address and port number are mutated.

FIG. 13B illustrates schematically a packet URL modifier in which the URL information carried in the packet is mutated to a new one.

FIG. 14A shows the interactions between various components of the wireless network system in order to enable local content to be served where packets from a HTTP wireless client are modified in a one-stage process.

FIG. 14B shows the interactions between various components of the wireless network system in order to enable local content to be served where packets from a WAP wireless client are modified in a one-stage process.

FIG. 15A shows the interactions between various components of the wireless network system in order to enable local content to be served where packets from a HTTP wireless client are modified in a two-stage process.

FIG. 15B shows the interactions between various components of the wireless network system in order to enable local content to be served where packets from a WAP wireless client are modified in a two-stage process.

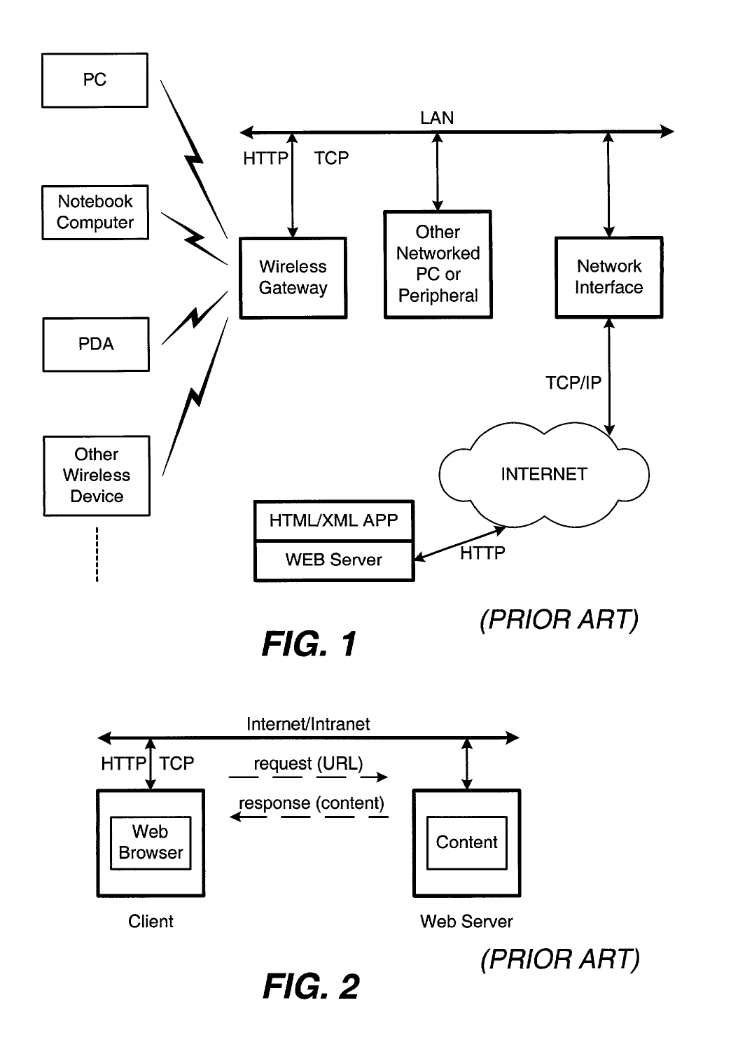

### DETAILED DESCRIPTION OF THE PREFERRED EMBODIMENT

Local Wireless Service Area Network

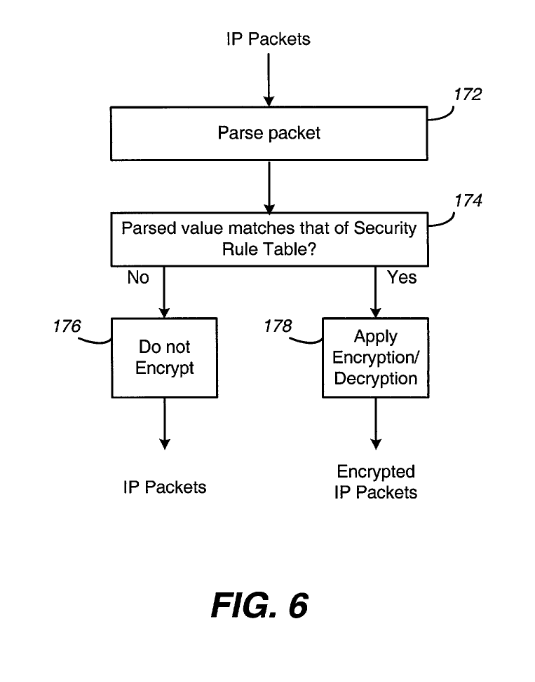

FIG. 5 illustrates a wireless network system that provides wireless devices in a wireless service area access to content hosted on the Intranet/Internet, according to a preferred embodiment of the invention. The wireless network system enables connectivity between a wireless device 10 and an IP network that is part of an intranet 20 and the Internet 30. In the preferred embodiment, the connectivity is enabled by a collection of wireless gateways 40, an access server 50, and a WAP gateway 60.

The wireless device 10 is typically a smart mobile phone or portable information appliance, but can also be a wireless-enabled desktop computer or other non-portable information appliance. The wireless gateway 40 serves as an access point for a wireless device to the IP network 20, 30 and therefore provides not only WLAN (Wireless LAN) functions but also a conduit to resources on the Internet/Intranet. Each wireless gateway, or a cluster of wireless gateways, defines a wireless service area 100, also referred to as a “piconet”. The extent of each wireless service area is dictated by the power transmission and the protocol adopted in its common air interface, such as Bluetooth or IEEE 802.11. In either example, the wireless gateway has a range from 10 to 100 meters, which forms a piconet sufficient to cover premises such as a home or a small office. Larger premises like shopping malls or airport terminals can be covered by a more extensive piconet formed by a cluster of wireless gateways.

In the preferred embodiment, the wireless device 10 and the wireless gateway 40 conform to the Bluetooth specification described earlier. Complete Bluetooth documentation and specification are published on the official Bluetooth Special Interest Group's website (http://bluetooth.com) noted earlier. All relevant Bluetooth publications available from the website are incorporated herein by reference.

FIG. 5 illustrates an example of the wireless network system supporting two wireless service areas in two different segments of the intranet 20. Wireless signals of the wireless device 10 are translated across a wireless gateway 40 into IP packets on the IP network and vice versa. A network interface 110 serves as a router connecting different segments of the IP network.

As described earlier, a wireless device, appropriately enabled, acts as a client requesting content from a content server on the IP network. The nature of each type of client predicates in what optimum manner and format the content should be delivered. In the preferred embodiment, the wireless network system supports at least two types of wireless clients, each type for browsing content created in an environment with its own application protocol and transport protocol.

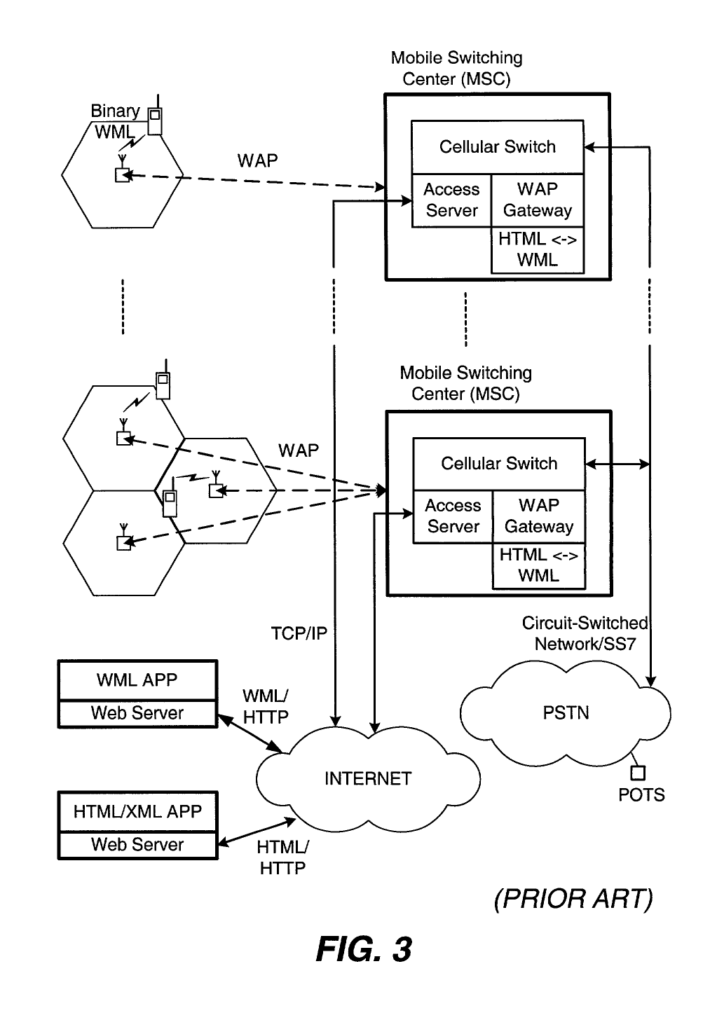

One type of client is a HTTP client. This would include a wireless-enabled desktop or notebook computer running a standard browser for browsing HTML content retrieved from the IP network. As described in connection with FIG. 2, the application protocol over the transport protocol used is HTTP/TCP. Content coded in HTML is one form of a HTML/XML application 120 that is typically hosted by a web server 130 on the IP network. HTML coded content is designed to be accessed by a HTTP client directly from the IP network. In that case, the network interface 110 simply needs to route the packets between the intranet 20 and the Internet 30.

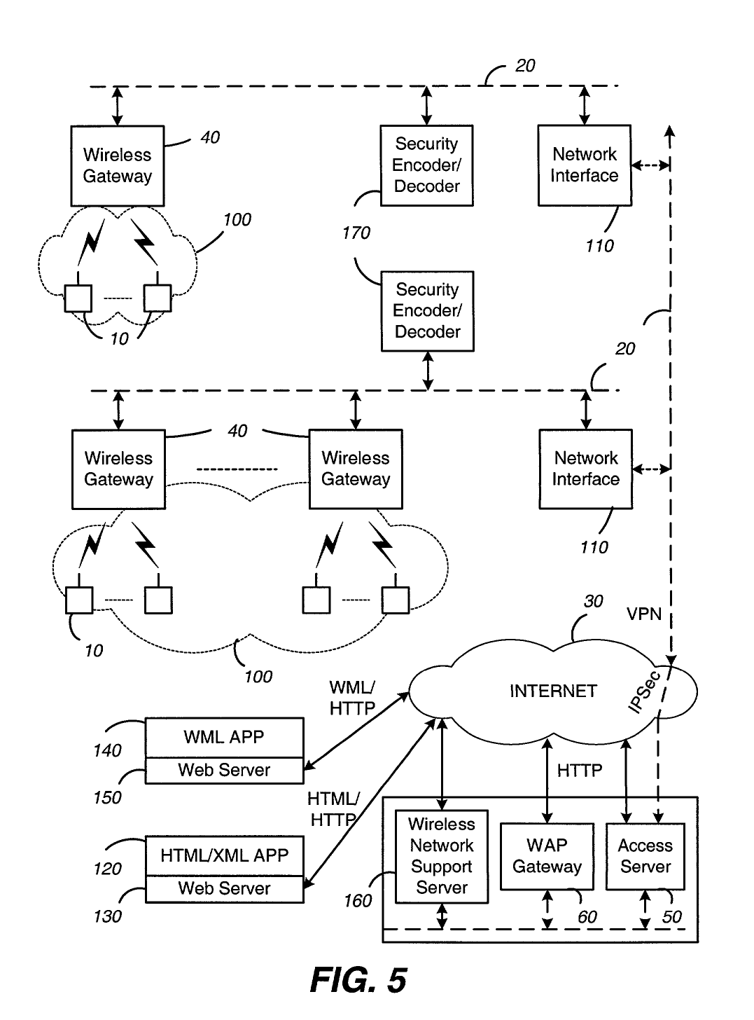

The second type of client is a WAP client. This would include a WAP-enabled cell phone or pager or palm-top PDA running a WAP compatible microbrowser. In this case, the WAP gateway 60 is required to translate between WML/HTTP and WAP/UDP as described in connection with FIG. 4. The WAP gateway introduces WAP capabilities into the IP network, and allows the wireless service provider to introduce new, differentiated and advanced features as value-added services, such as local and Internet content and advanced data services to the end-user.

WAP applications such as WML content 140 are typically hosted by web or application servers 150 on the IP network separate from the WAP gateway 60. The application server can be located anywhere on the IP network as long as the WAP gateway is allowed to act between the WAP applications and its clients.

Additional servers, such as a wireless network support server 160, are optionally deployed on the IP network to provide various value-added features including translating between HTML and WML content, local content hosting, and network control and administration.

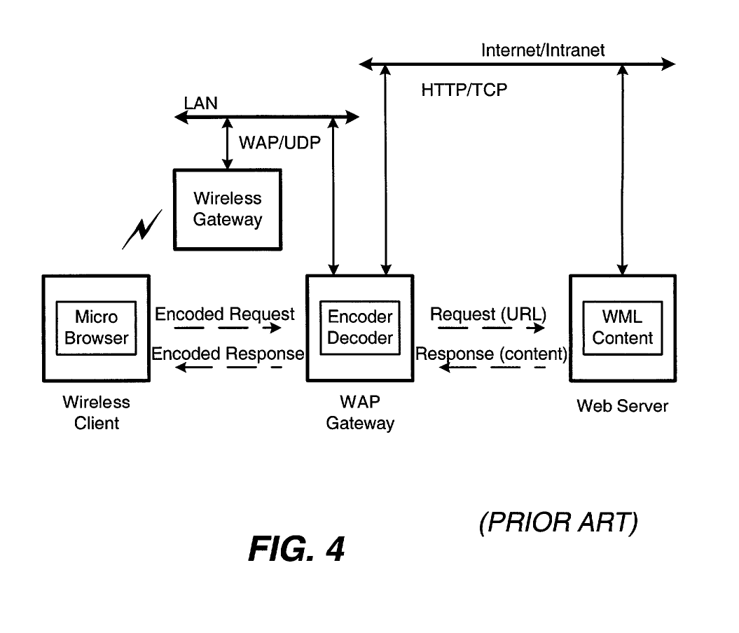

One aspect of the invention is to provide a WAP enabled wireless network that is economical and efficient. Existing WAP enabled networks such as the cellular telecommunication network shown in FIG. 3 have the WAP gateway co-located at each wireless gateway. This arrangement is preferable in order to adequately support a large number of subscribers in the cellular environment, and in order to protect the security of the link between the client and the WAP gateway by placing it in a private facility. This link is running WAP/UDP, which by its very design is lightweight in terms of making less demand on bandwidth, latency, connection stability and processor power on the wireless portion of the link. Although the WAP protocol stack does contain WTLS (Wireless Transport Layer Security), which is the security counterpart to SSL (Secure Socket Layer) in the HTTP stack, the light-weight design has been optimized for use over narrow-band communication channels. This may lead to a less secure and less robust encryption. In any case, the WTLS encryption is performed on the client device and therefore places extra burden on the processor of a “thin” client device. Thus the security and performance offered by WTLS in WAP may not be desirable in some applications.

This aspect of the invention provides a wireless network architecture that avoids having to assign a WAP gateway to be co-located with every wireless gateway or every piconet without, while providing alternative and enhanced security features. This is accomplished by assigning one or a limited number of WAP gateway to service the whole wireless network. The WAP gateway can be located anywhere as long as it is accessible to the wireless network and the link to it is secured. In one embodiment, the WAP gateway is connected to the private IP network via a leased telecommunication line so that no part of it is accessible to the public. In the preferred embodiment, a more economical and flexible arrangement is to connect the WAP gateway to the private IP network using the public Internet 30. Security is accomplished by establishing a VPN (Virtual Private Network) employing IPsec (IP Security Protocol) for the packets of the IP network to tunnel through the Internet 30.

As shown in FIG. 5, the dashed lines represent segments of the IP network that are private. In particular, IPsec is used in the portion of the link furnished by the public Internet 30. The IPsec protocol is preferably implemented as a software stack, one on each side of the link across the Internet 30.

In one embodiment, on the wireless side, a security encoder/decoder 170 encrypts the UDP packets under the IPsec protocol. After tunneling through the Internet, this is then terminated at a corresponding stack resident in the access server 50.

In general, depending on implementations, the functionalities of the security encoder/decoder 170 can be incorporated into either the wireless gateway 40 or the network interface 110 or as a separate processor in between. In one embodiment, the security encoder/decoder is implemented as a rule-based encryption-decryption engine.

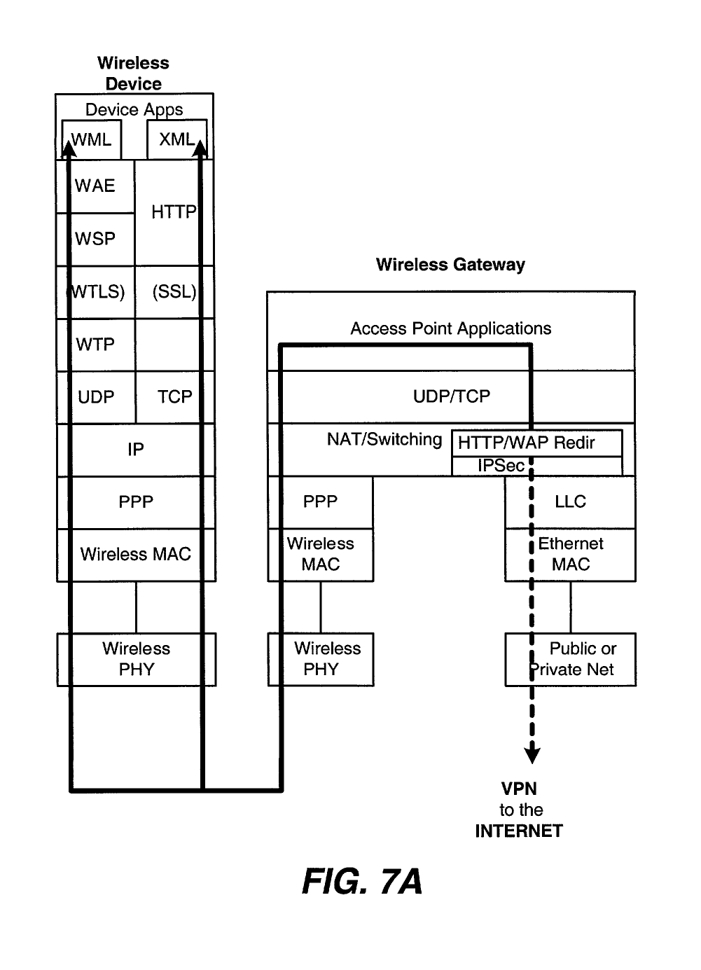

FIG. 6 illustrates the process of the security encoder/decoder of FIG. 5 implemented as a rule-based encryption-decryption engine. First a security rule table is established to specify whether a given security protocol should be applied to a packet based on the content parsed from the packet. The rule-based encryption-decryption engine operates with the following steps:

Step 172: an input packet is parsed for examining a set of one or more field value relevant to the security rule table.

Step 174: if the set of parsed value does not match an encryption rule of the security rule table, the process proceeds to Step 176, otherwise the process proceeds to Step 178.

Step 176: the IP packet is output unmodified.

Step 178: the IP packet is encrypted according to the protocol specified in the security rule table before it is output.

Using a secured connection across the Internet to share a WAP gateway among the wireless gateways provides a wireless network that is economical, and efficient to manage, maintain and administer. Since the encryption process is off-loaded from the client device to the network infrastructure, performance degradation incurred from secure transactions is reduced. Furthermore, implementing a rule-based secured transport avoids incurring overheads on those applications that do not require security.

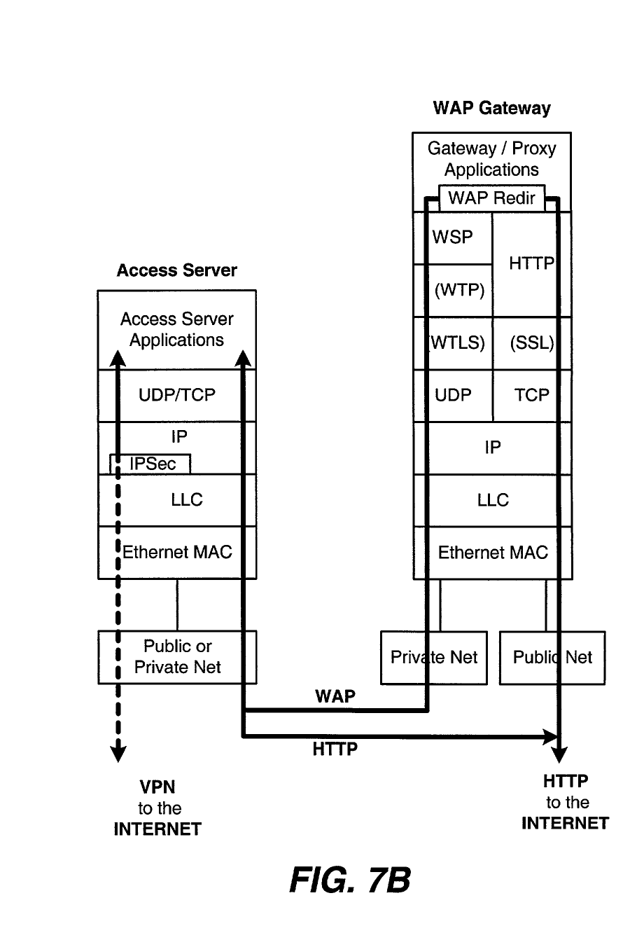

FIGS. 7A and 7B together illustrate a preferred implementation of the signal path and the protocol stacks starting from a wireless device that conforms to the Bluetooth wireless specification through to a WAP gateway as shown in FIG. 5.

FIG. 7A illustrates the path and protocol stacks from a wireless device through a wireless gateway and then tunneling through the Internet. The protocol stacks at the wireless device 10 comprises at least one of two application protocol stacks on top of IP transport stack followed by the Bluetooth wireless stack that meets the Bluetooth LAN access profile.

As described before, the wireless device 10 shown in FIG. 5 can be a member of a WLAN operating with TCP/IP, and in particular can act as a HTTP client able to browse HTML content. It incorporates the HTTP stack as the application protocol stack on top of the IP transport stack. The HTTP stack comprises a HTTP layer on top of an optional SSL (Secure Socket Layer) followed by the IP transport stack comprising TCP/IP/PPP layers. The HTML/XML codes or scripts terminate at the top of the HTTP stack.

The wireless device 10 shown in FIG. 5 can also act as a WAP client able to browse WML content. It incorporates the WAP stack as the application protocol stack on top of the IP transport stack. The WAP stack comprises, from top to bottom, a WAE (Wireless Application Environment) layer, a WSP (Wireless Session Protocol) layer, a WTP (Wireless Transaction Protocol) layer, a WTLS (Wireless Transport Layer Security) layer, and a WDP (Wireless Datagram Protocol) layer. The WML codes and scripts terminate at the top of the WAP stack.

The IP transport stack for WAP comprises UDP/IP/PPP. Basically, UDP (User Datagram Protocol) is used in the WDP layer when in the IP environment. PPP (Point-to-Point Protocol) is the preferred protocol for modem connection to the Internet in order for WAP to support telephony applications.

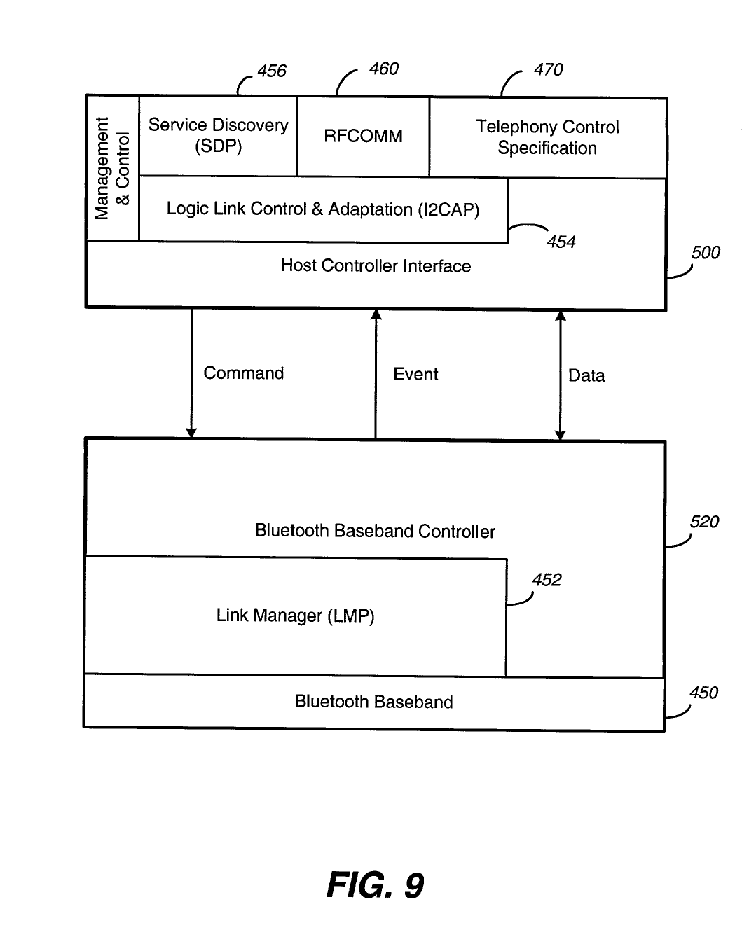

Thereafter, one of the two alternative protocol applications on top of their associated IP transport stack shares a common wireless stack. The LAN access stack is the Wireless MAC (Media Access Control) layer that interfaces with the Wireless Physical layer. The actual Bluetooth wireless stack is shown in FIG. 9.

A wireless connection is made between the wireless device and the wireless gateway. The wireless gateway terminates the Bluetooth and PPP protocols; maps the wireless device's private IP address to a public IP address using NAT (Network Address Translation); and then sends the UDP packets to the access server through the IPsec tunnel.

FIG. 7B illustrates the tunneling path from FIG. 7A through the Internet to the access server and then to the WAP gateway before connecting to the Internet again. The IPsec protocol stack is terminated at the access server. If the packets are in TCP, the access server simply passes the TCP packets onto the Internet. If the packets are in UDP, the access server passes the UDP packets onto the WAP gateway. In addition, the access server also authenticates the Wireless devices, so that only authorized wireless devices can use the WAP gateway.

For secure data transactions, the gateway uses WTLS and SSL to communicate with mobile clients and Internet web servers, respectively. Additional security measures, such as PKI (Public Key Infrastructure), can be built on the top of the WAP protocol stack for e-commerce applications using wireless mobile clients.

In addition to the WAP applications, the wireless gateway also provides wireless LAN functions. In that case, the data traffic between the wireless devices and other computers on the IP network can be routed through the IP layer without the NAT.

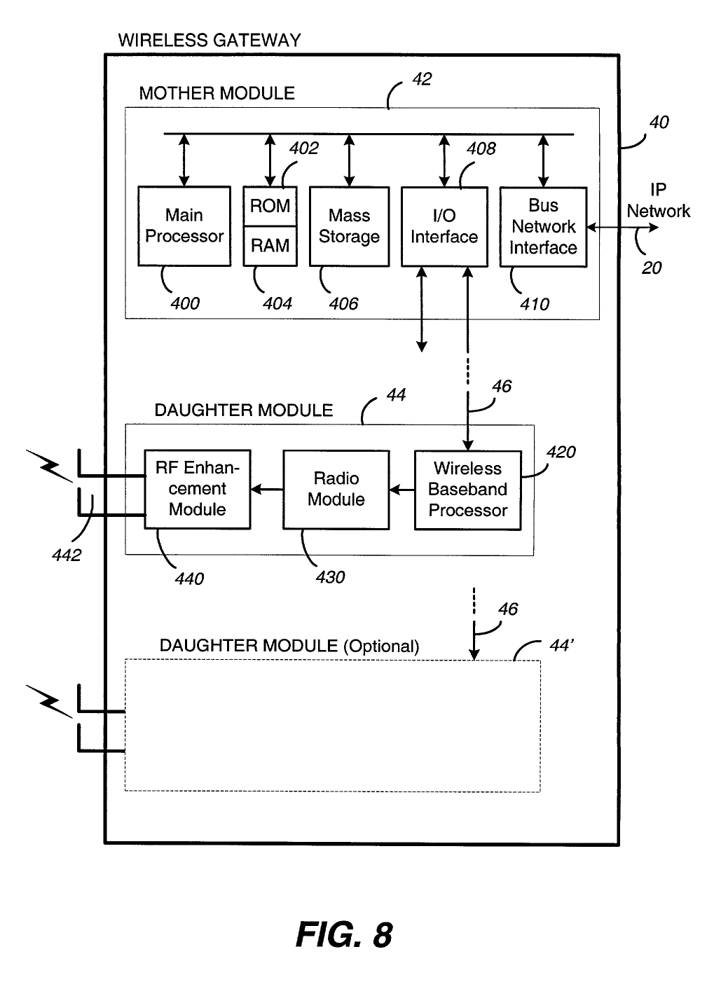

FIG. 8 is a schematic hardware functional block diagram of the wireless gateway shown in FIG. 5. In the preferred implementation, the wireless gateway 40 consists of a motherboard 42 and a daughterboard 44 that are interconnected via a USB/UART (Universal Serial Bus/Universal Asynchronous Receiver-Transmitter) connection 46. The motherboard comprises a main processor 400, ROM (Read Only Memory) 402, RAM (Random Access Memory) 404, mass storage 406, an I/O (Input/Output) interface 408 and a bus network interface 410 for interfacing with the IP network 20. The daughter board comprises a Baseband processor 420, a Bluetooth radio module 430, and a RF enhancement module 440 that includes a power amplifier, a low-noise amplifier, two Transmitter/Receiver switches, and two antennas 442. The USB/UART connection 46 allows additional daughterboards 44′ to be used.

FIG. 9 illustrates the Bluetooth protocol stack running on the Bluetooth main processor on the motherboard and on the baseband processor on the daughterboard according to the Bluetooth specification. The Bluetooth protocol stack can be divided into four layers consisting of Bluetooth Core Protocol, Cable Replacement Protocol, Telephony Control Protocols and Adopted Protocols. The Bluetooth Core Protocols layer includes Baseband 450, LMP (Link Manager Protocol) 452, L2CAP (Logic Link Control & Adaptation) 454 and SDP (Service Discovery Protocol) 456. The Cable Replacement Protocol layer includes RFCOMM 460. The Telephony Control Protocols layer 470 includes AT-commands. The Adopted Protocols layer includes PPP, UDT/TCP/IP, WAP, WAE. Applications sit at the top of the Bluetooth stack.

In addition to the above protocol layers, a Host Controller Interface 500 is also defined. The Host Controller Interface provides a command interface to the baseband controller 520, link manager 452, and access to hardware status and control registers.

The networking protocols shown in FIG. 7A and the particular Bluetooth protocol illustrated in FIG. 9 are executed on the motherboard. The Link Management Protocol (LMP) and the baseband controller interface are run in the baseband processor.

Local-Content Service in a Wireless Service Area

According to another aspect of the invention, a system and method of serving local content enable the local content to be actively presented to a mobile wireless user operating in a wireless service area. The local content is information that may be of interest to a mobile user when in the localities or neighborhood covered by the given wireless service area. Alternatively, the local content is information that vendors and businesses in the localities or neighborhood would like to the mobile user to know about. For example, when in an airport terminal, the local content of interest may be the flight schedules of the airlines operating in the terminal, or it may be about the shops and facilities in the terminal. When in a shopping mall, the local content of interest may be about the resident shops and services.

When a mobile user is operating in a wireless service area, the local content is actively presented to the mobile user as an option. In one implementation, when a mobile user initially attempts to access a resource on the Internet/Intranet, the mobile user is automatically redirected to the local content or presented with an option to access the local content. In a preferred implementation, the mobile user can easily navigate between accessing content from the Internet/Intranet and accessing local content. In contrast, conventional methods of serving content of interest to a particular locality require the mobile user to identify the location before the content server can return the relevant local content.

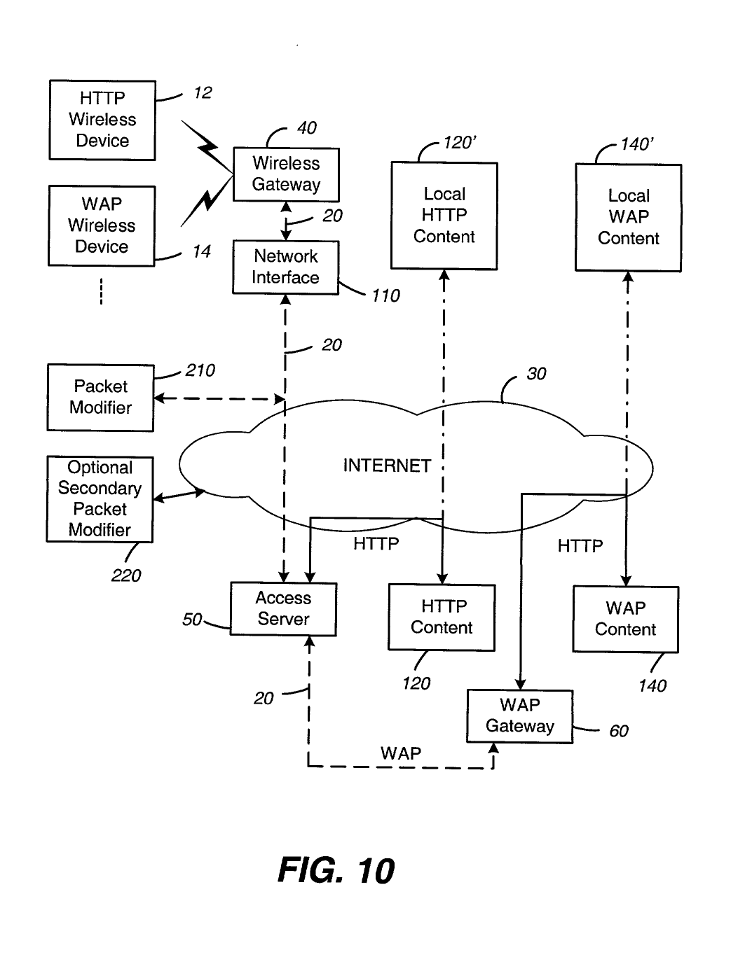

FIG. 10 is a schematic diagram showing a general system architecture where the wireless network system of FIG. 5 is adapted to serve local content, according to a preferred embodiment of the invention. As described in connection with FIG. 5, the wireless gateway 40 provides a wireless access point for a plurality of mobile users with their wireless devices to connect to the private network 20. For both HTTP and WAP wireless devices, the private network 20 allows connection through the network interface 110 and the secure tunnel through the public Internet to the access server 50. For HTTP wireless devices, the access server leads to the Internet. For WAP wireless devices, the access server leads to the WAP gateway 60 before connecting to the Internet. In this way, a mobile user's wireless device operating as a HTTP client is able to access HTTP content 120 on the Internet/Intranet. Similar, a mobile user's wireless device operating as a WAP client is able to access WAP content 140 on the Internet/Intranet via the WAP gateway 60.

Local content is made available by hosting it on a web server on the Internet/Intranet. Although FIG. 10 illustrates HTTP and WAP as two example application protocols, others are also contemplated. In general, each type of application protocol requires its own version of the local content. For the present example, a local HTTP content 120′ and a local WAP content 140′ are made available on the Internet/Intranet.

Local content is actively served to a wireless client when the client attempts to request content from the Internet/Intranet. This is accomplished by either mutating the packets of the requesting client to cause local content to be returned to the client instead, or mutating the packets of the returned content to have the requested content include added local content.

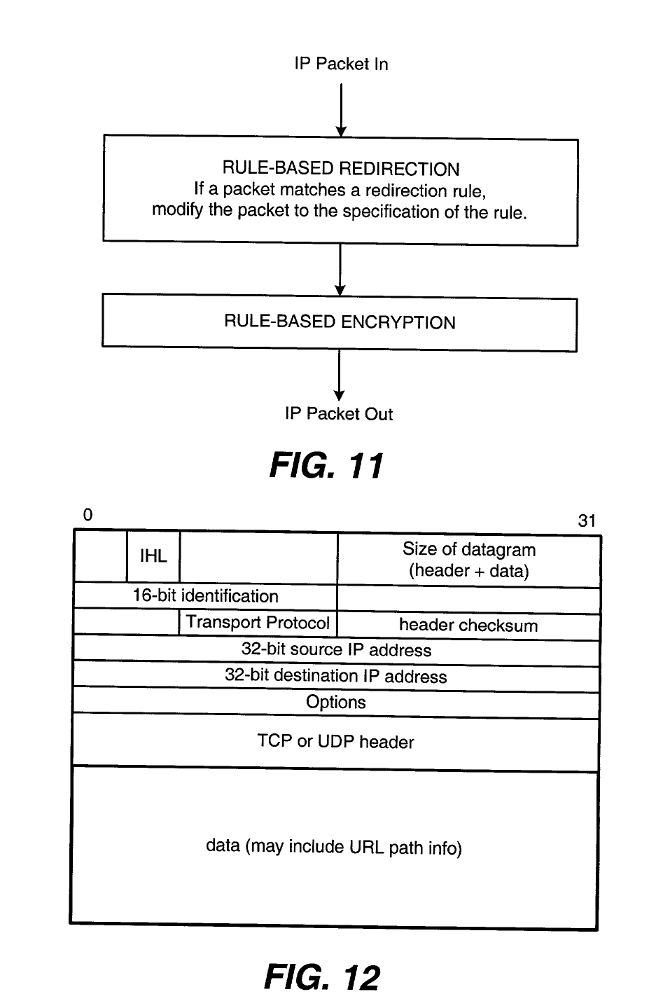

FIG. 11 illustrates a preferred scheme for processing packets to implement packet modifications such as packet mutation and packet encryption. Essentially, what is done to a packet depends on the information carried in it. A rule table is complied, listing how the packet is to be processed when it carries certain data. Each packet is examined against the rule table for those certain data and processed accordingly if there is a match.

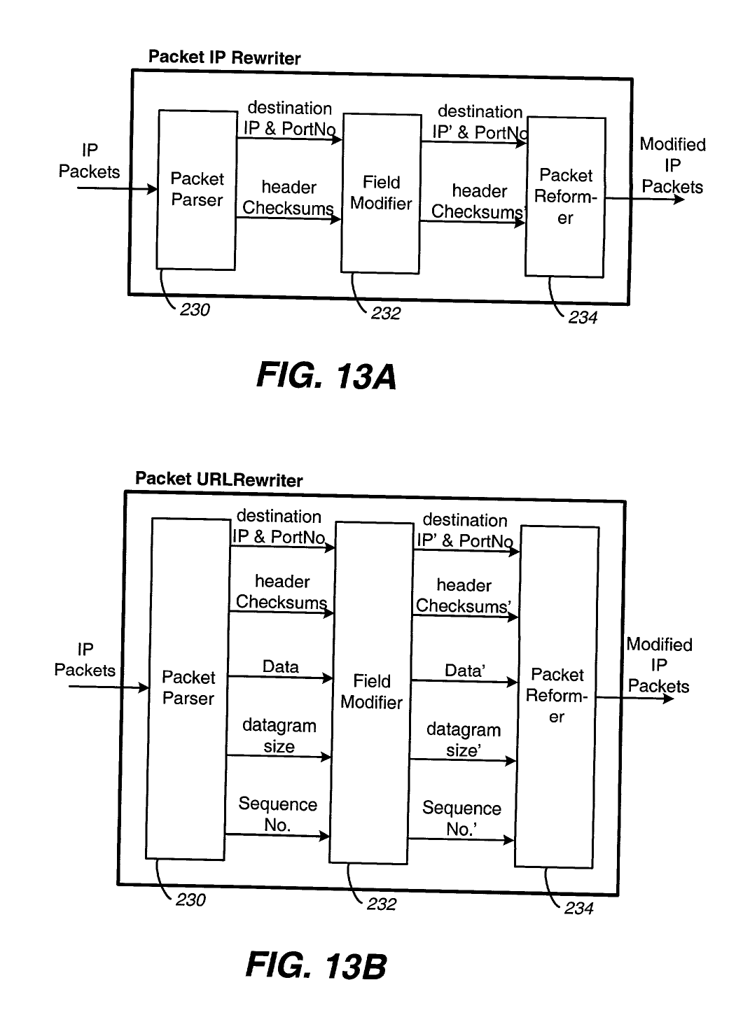

FIG. 12 illustrates the information carried in an IP packet. It contains headers for the different protocols and their corresponding data portions. Packet mutation involves changing one or more field values in the headers and/or data portion.

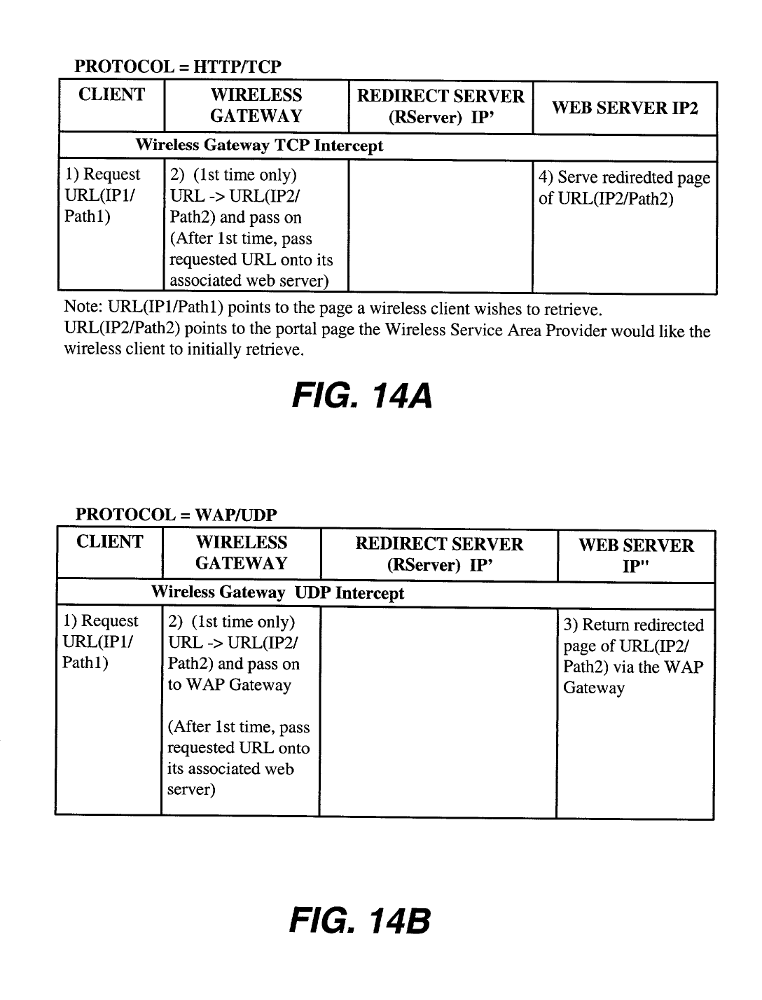

FIG. 13A illustrates schematically a packet IP modifier in which the destination IP address and port number are mutated. A packet parser 230 allows the fields pertaining the destination IP address and the destination Port number to be accessed. The various header checksums also need to be recalculated and changed to be consistent. A field modifier 232 changes the field values to their new values and the mutated packet is assembled and output by a packet reformer 234.

FIG. 13B illustrates schematically a packet URL modifier in which the URL information carried in the packet is mutated to a new one. The URL information comprises the IP address of the server hosting the resource and the path at the server leading to the resource. Thus, the packet modifier is similar to that shown in FIG. 13A, except in addition to mutating the destination IP address and port number, the data portion containing the destination path information is also mutated. Also, related fields, such as header checksums, datagram size and TCP sequence number need to be recalculated and modified at the same time to be consistent.

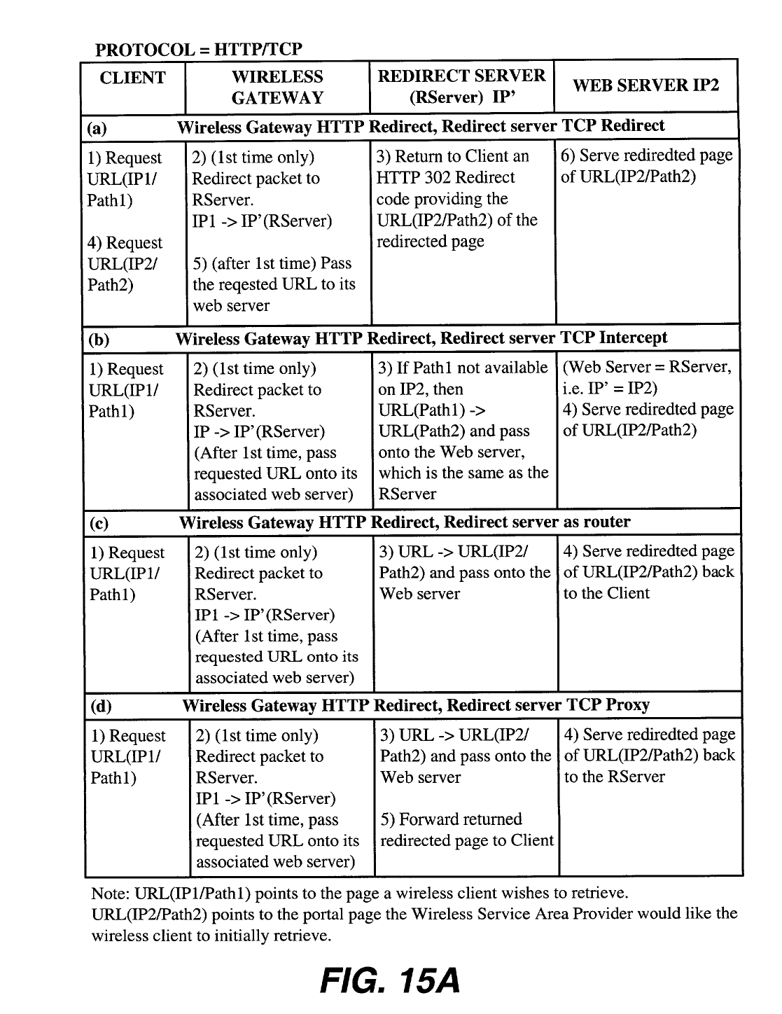

FIG. 14A shows the interactions between various components of the wireless network system in order to enable local content to be served where packets from a HTTP wireless client are modified in a one-stage process.

FIG. 14B shows the interactions between various components of the wireless network system in order to enable local content to be served where packets from a WAP wireless client are modified in a one-stage process.

A packet modifier 210 intercepts the packets from the wireless client requesting content and processes the packets to cause them to request and return local content to the client. Generally, when a wireless device attempts to access content, it requests a specific content by sending an URL pointing to the server and path where the specific content is to be found on the Internet/Intranet.

In order to cause the packets from the requesting client to request and return local content instead, the packet modifier 210 is implemented as in the packet URL modifier shown in FIG. 13B. The URL specified in the packet originally pointing to the content requested by the client is mutated to a URL′ pointing to the local content that the local content provider would like the client to see.

The packet modifier 210 is strategically situated to intercept the packets from the client before they have a chance to go to their destinations. FIGS. 14A and 14B provide an examples of the packet modifier 210 to be resident in the wireless gateway 40. In general, as can be seen in FIG. 10, the packet modifier 210 can be incorporated into the wireless gateway 40, or the network interface 110 or the access server 50, or into an additional server (not shown) situated on the private IP network 20 between the wireless gateway 40 and the access server 50. For modifying packets from a WAP client, the packet modifier 210 can even be situated as far down as the WAP gateway 60.

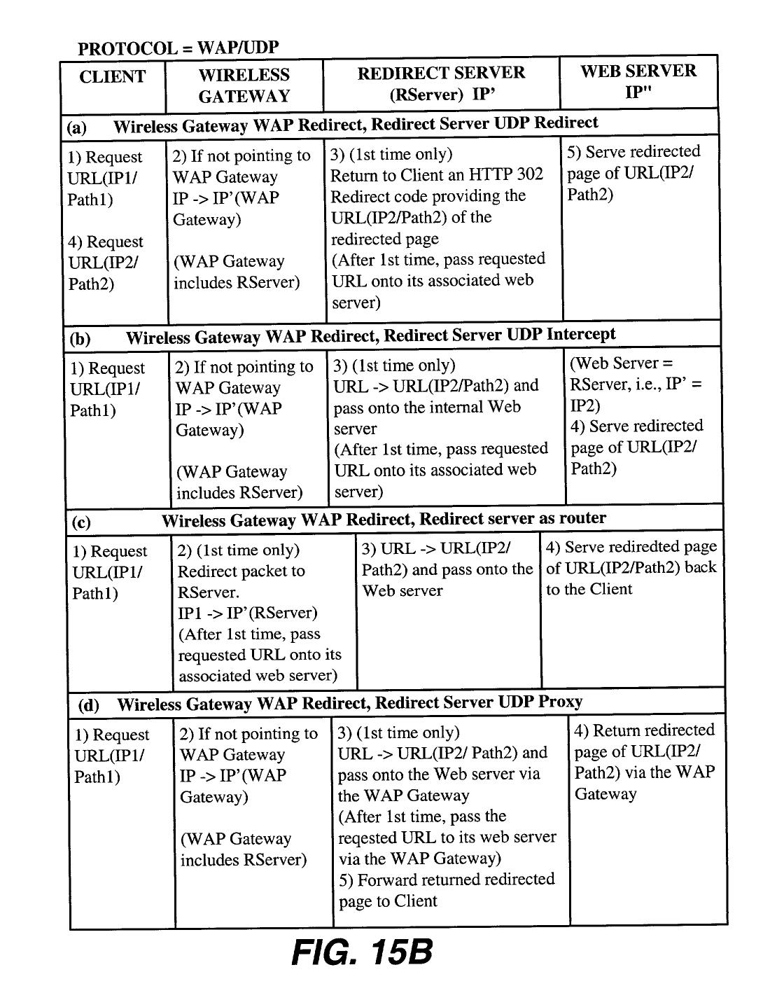

FIG. 15A shows the interactions between various components of the wireless network system in order to enable local content to be served where packets from a HTTP wireless client are modified in a two-stage process.

FIG. 15B shows the interactions between various components of the wireless network system in order to enable local content to be served where packets from a WAP wireless client are modified in a two-stage process.

The packet modifier 210 serves a primary function of intercepting the packets from the wireless client from a strategic location on the IP network and causing them to be redirected to a second packet modifier 220 that can be situated anywhere on the IP network, including the Internet 30. The second packet modifier 220 can then process the packets to cause them to request and return local content to the client.

In order to cause the packets from the requesting client to request and return local content instead, the packet modifier 210 works in tandem with the second packet modifier 220.

In the first stage, the packet modifier 210 is implemented as in the packet IP modifier shown in FIG. 13A. Thus, the destination IP address specified in the packet originally pointing to the content requested by the client is mutated to a IP″ address pointing to a server hosting the second packet modifier 220. This has the effect of redirecting the packets to the second packet modifier 220.

FIGS. 15A and 15B provide an examples of the packet modifier 210 to be resident in the wireless gateway 40. In general, the packet modifier 210 can be situated elsewhere as noted earlier.

In the second stage, several implementations are contemplated. In a first implementation a), the second packet modifier 220 is implemented as a standard HTTP redirect server, where a HTTP 302 redirect code is returned to the client along with the URL′ pointing to the local content that the local content provider would like the client to see. The client then reissue a new request with URL′ pointing to the local content and retrieves the local content.

In a second implementation b), the second packet modifier 220 is co-hosted with the local content on the same server. The second packet modifier 220 inspects the packets as to the path information and matches that with that from the rule table described in connection with FIG. 11. If the path is not available on the server, then the second packet modifier 220 mutates the path value in the packet to that pointing to the local content residing on the server and passes the mutated packet onto the server to request the local content. In response, the server returns the local content to the client.

In a third implementation c), the second packet modifier 220 is implemented as a router. The URL specified in the packet originally pointing to the content requested by the client is mutated to a URL′ pointing to the local content that the local content provider would like the client to see. The mutated packets result in the local content being requested and returned to the client instead.

In a fourth implementation d), the second packet modifier 220 behaves like a modifying proxy where requests handed to it are mutated at the proxy to request local content instead. The requested local content is returned to the proxy to be forwarded the client. The packet modifier 220 is implemented as in the packet URL modifier shown in FIG. 13B. The URL specified in the packet originally pointing to the content requested by the client is mutated to a URL′ pointing to the local content that the local content provider would like the client to see. The mutated packets result in local content being requested and returned to the proxy for forwarding back to the client.

In yet another embodiment of enabling local content to be served, the modification is performed on the packets of the returned content requested by the wireless client to so that the requested content is returned with added local content.

One form of the added local content is a link to the home page of a website serving local content. For example, the mobile user would have the option of clicking on a local link to obtain location-specific information, such as the homepage of a shopping mall or an airport. This requires the local link to be inserted in a returned page and is accomplished by intercepting the packets of the returned page and modifying the data portion of the packets to include the local link on the returned page.

Another form of the added local content is a local-content link that depends on the content the mobile user is currently requesting. For example, if the mobile user is requesting content from a national bookseller, a link to local booksellers may be appended to the returned page from the national bookseller. This requires the establishment of a database or table of keywords and associated links. The packets associated with a mobile user's browsing activity are monitored and the keywords parsed from the packets are used to look up the associated local links. The data portion of the packets associated with the returned page is then modified such that the returned page includes the local links.

Based on the described scheme of inserting local links into displayed contents of a mobile device, a possible scenario is as follows. A mobile device gets connected to a wireless gateway such as an access point and attempts to gain access to the Internet. The access point intercepts the flow and sends a local home page to the device to be displayed. The display may include two mark-up texts, “Local” and “Internet”. A user would then have the option of clicking either on the mark-up text “Local” which takes the user to a local home page or clicking on the mark-up text “Internet” which takes him to a destination server of his own choosing out in the Internet. Once a user goes to the Internet, a local content icon LC will be added to the end of each display area. In addition, optionally a card of more detailed local links could be inserted into each WML deck.

According to another aspect of the invention, each wireless client device has an identification number (ID), and the packet modifier incorporates the device ID into the IP packets originated from each wireless client. This is accomplished by the wireless network system noting the device ID of the wireless device signing on and intercepting and modifying the packets originating from the wireless client to include the device ID. This allows the system to better keep track of client activities and history and to serve local content more intelligently accordingly.

Thus, the invention provides a particularly simple and effective solution to the problems stated in the introduction.

While the embodiments of the various aspects of the present invention that have been described are the preferred implementation, those skilled in the art will understand that variations thereof may also be possible.

Therefore, the invention is entitled to protection within the full scope of the appended claims.

It is claimed:

1. A system for serving content residing on an Internet protocol (IP) network to a plurality of wireless client devices in a wireless service area, comprising:
at least one wireless gateway for wirelessly connecting said plurality of wireless client devices to said IP network, said wireless gateway converting between wireless signals and IP packets, wherein each IP packet includes a header specifying a transport protocol, and a destination IP address;
a plurality of content applications, each under a given application protocol, for providing content accessible from said IP network, the content including a first type and a second type;
a content redirector associated with each content application for causing content of a second type to be served when a wireless client device attempts to access content of a first type.

2. A system as in claim 1, wherein said content of the first type includes content of general interest not necessarily specific to a given wireless service area in which a wireless device is operating.

3. A system as in claim 1, wherein said content of the second type includes content specific to a given wireless service area in which a wireless device is operating.

4. A system as in claim 1, wherein said plurality of content applications include Wireless Markup Language (WML) applications under the Wireless Application Protocol (WAP) and the associated transport protocol is User Datagram Protocol (UDP).

5. A system as in claim 1, wherein said plurality of content applications include HyperText Markup Language (HTML) applications under the HyperText Transfer Protocol (HTTP) and the associated transport protocol is Transmission Control Protocol (TCP).

6. A system as in claim 1, wherein said content redirector includes a packet modifier that modifies the destination IP address of packets originating from the wireless client device to point to a server hosting the content of the second type.

7. A system as in claim 1, wherein the content redirector includes a packet modifier that modifies the Uniform Resource Locator of packets originating from the wireless client device to point to the content of the second type.

8. A system as in claim 1, wherein the content redirector includes:
a first packet modifier and a second packet modifier;
said first packet modfier modifying the destination IP address of packets originating from the wireless client device to redirect the packets to said second packet modifier; and
said second packet modifier modifying the redirected packets such that content of the second type is served when a wireless client device originally attempted to access content of a first type.

9. A system as in claim 8, wherein said second packet modifier modifies the Uniform Resource Locator of the redirected packets to point to the content of the second type.

10. A system as in claim 1, wherein
each wireless client device is associated with an identity number; and
said packet modifier incorporates into the IP packets originating from a wireless client its associated identity number.

11. A system as in anyone of claims 1-10, wherein the IP network includes the Internet.

12. A system as in anyone of claims 1-10, wherein the IP network includes a private segment not publicly accessible.

13. A method of serving content residing on an Internet protocol (IP) network to a plurality of wireless client devices in a wireless service area, comprising:
providing at least one wireless gateway for wirelessly connecting said plurality of wireless client devices to said IP network, said wireless gateway converting between wireless signals and IP packets, wherein each IP packet includes a header specifying a transport protocol, and a destination IP address;
providing a plurality of content applications, each under a given application protocol, for providing content accessible from said IP network, the content including a first type and a second type;
redirecting content associated with each content application such that content of a second type is served when a wireless client device attempts to access content of a first type.

14. A method as in claim 13, wherein said step of redirecting content includes modifying the destination IP address of packets originating from the wireless client device to point to a server hosting the content of the second type.

15. A method as in claim 13, wherein said step of redirecting content includes modifying the Uniform Resource Locator of packets originating from the wireless client device to point to the content of the second type.

16. A method as in claim 13, wherein said step of redirecting content includes:
modifying the destination IP address of packets originating from the wireless client device to redirect the packets to a predetermined location; and
modifying the redirected packets at the predetermined location such that content of the second type is served when a wireless client device originally attempted to access content of a first type.

17. A method as in claim 16, wherein said step of modifying the redirected packets at the predetermined location includes modifying the Uniform Resource Locator of the redirected packets to point to the content of the second type.

18. A method as in claim 13, wherein each wireless client device is associated with an identity number; and the step of redirecting content includes modifying the packets originating from the wireless client device to incorporate the identity number associated with the wireless client device.

19. A wireless network, comprising:
a private segment of an Internet Protocol (IP) network;
a wireless gateway for wirelessly coupling one or more wireless device to said private segment of the IP network so as to convert between wireless signals and IP packets;
a Wireless Application Protocol (WAP) gateway;
an access server for providing the private segment of the IP network access to the Internet and to the WAP gateway; and
a secure connection through the Internet for providing a private link between said private segment of an IP network and said access server.

20. A wireless network, as in claim 19, further comprising:
a packet inspector for inspecting information contained in the IP packets
a set of encryption/decryption rules for prescribing encryption/decryption to a IP packet based on the information contained in the IP packet; and
an encryption decryption engine for executing the encryption/decryption accordingly.
